(19) United States
(12) Patent Application Publication
(10) Pub. No.: US 2026/0034853 A1
(43) Pub. Date: Feb. 5, 2026

(54) VEHICULAR AIR-CONDITIONING DEVICE FOR COOLING AND HEATING

(71) Applicants: HYUNDAI MOTOR COMPANY, Seoul (KR); KIA CORPORATION, Seoul (KR); DOOWON CLIMATE CONTROL CO.,LTD, Asan-si (KR)

(72) Inventors: Sang Yeop Lee, Hwaseong-si (KR); Myung Hoe Kim, Hwaseong-si (KR); Gee Young Shin, Hwaseong-si (KR); Won Seo Kang, Cheonan-si (KR); Jun Sic Jung, Asan-si (KR)

(73) Assignees: HYUNDAI MOTOR COMPANY, Seoul (KR); KIA CORPORATION, Seoul (KR); DOOWON CLIMATE CONTROL CO.,LTD, Asan-si (KR)

(21) Appl. No.: 19/217,321

(22) Filed: May 23, 2025

(30) Foreign Application Priority Data
Aug. 5, 2024 (KR) 10-2024-0103590

(51) Int. Cl. B60H 1/00; B60H 1/32

(52) U.S. Cl. CPC B60H 1/00842; B60H 1/00028; B60H 1/00207; B60H 1/00807; B60H 1/3227; B60H 2001/00107; B60H 2001/00128; B60H 2001/00178; B60H 2001/00242

(57) ABSTRACT

A vehicular air-conditioning device for cooling and heating includes a refrigerant circulation passage formed in a housing, an air circulation passage located in the housing and configured to perform heat exchange with the refrigerant circulation passage, and a controller configured to receive an interior temperature from an interior temperature sensor of a vehicle and to operate a first switching door and a second switching door. The air circulation passage includes a blower, a first flow path formed between a first duct part located at one end of the housing and the blower, the first switching door configured to selectively open the first duct part, a second flow path formed between a second duct part located at the other end of the housing and the blower, and the second switching door configured to selectively open the second duct part.

### CROSS-REFERENCE TO RELATED APPLICATION

This application claims, under 35 U.S.C. § 119 (a), the benefit of and priority to Korean Patent Application No. 10-2024-0103590, filed on Aug. 5, 2024, the entire contents of which are incorporated herein by reference.

### BACKGROUND

### (a) Technical Field

The present disclosure relates to a vehicular air-conditioning device for cooling and heating, and more particularly, to an independent air-conditioning device configured to independently control cooling and heating in a rear seat area of a vehicle using all of the components of a heat pump independently of a main air-conditioning system.

### (b) Background Art

A vehicular air-conditioning device is configured to cool or heat the interior of a vehicle in summer or winter. Further, the vehicular air-conditioning device is a vehicle interior part installed to ensure a front view and a rear view of a driver by removing frost formed on the windshield on a rainy or cold day. Such an air-conditioning device is usually equipped with both a heating device and a cooling device. Therefore, the air-conditioning device selectively introduces outside air or inside air, heats or cools the air, and blows the air into the interior of the vehicle so as to cool, heat, or ventilate the interior of the vehicle.

The vehicular air-conditioning device generally refers to a front air-conditioning device having an outlet formed on a dashboard of the vehicle. However, recently, due to a large interior space provided in a sport utility vehicle (SUV), it is difficult to obtain sufficient cooling and heating effects using only the front air-conditioning device. Therefore, a rear air-conditioning device is additionally installed in medium and large vehicles.

In addition, a conventional air-conditioning device requires a blower for air circulation and a separate cooling fan for cooling of a condenser. Furthermore, when the temperature of air rises through heat exchange with the condenser, the air is discharged to the outside of the vehicle. Accordingly, there is a problem in that it is difficult to use such a heat source for heating.

In order to address the above-described problem, research and development has been actively conducted on a rear seat air-conditioning device capable of controlling heating and cooling using a single blower.

The above information disclosed in this Background section is only to enhance understanding of the background of the disclosure. Therefore, the Background section may contain information that does not form the prior art that is already known to a person of ordinary skill in the art.

### SUMMARY

The present disclosure has been made in an effort to solve the above-described problems associated with the prior art. It is an object of the present disclosure to provide an independent air-conditioning device including all of the components of a heat pump, such as a compressor, a condenser, an expansion valve, and an evaporator. The air-conditioning device is mounted on a C-pillar of a vehicle to control cooling and heating of a rear seat area of the vehicle. Furthermore, the air-conditioning device according to an embodiment of the present disclosure may use a single blower configured to allow air to circulate through the evaporator and condenser. The air-conditioning device may allow the air that has undergone heat exchange to flow into the interior or exterior of the vehicle by utilizing switching doors respectively located at an upper portion and a lower portion of a housing, thereby appropriately performing cooling and heating control. Therefore, one of the purposes of the present disclosure is to provide a device capable of independently controlling cooling and heating of a rear seat area of a vehicle.

The objects of the present disclosure are not limited to the above-mentioned objects. Other technical objects not mentioned herein should be more clearly understood by those having ordinary skill in the art to which the present disclosure pertains from the detailed description of embodiments. Additionally, the objects of the present disclosure may be achieved by means and combinations thereof as indicated in the claims.

In one aspect, the present disclosure provides a vehicular air-conditioning device for cooling and heating. The vehicular air-conditioning device includes a refrigerant circulation passage formed in a housing, an air circulation passage located in the housing and configured to perform heat exchange with the refrigerant circulation passage, and a controller configured to receive an interior temperature from an interior temperature sensor of a vehicle. The air circulation passage includes a blower, a first flow path formed between a first duct part located at one end of the housing and the blower, a first switching door configured to selectively open the first duct part, a second flow path formed between a second duct part located at the other end of the housing and the blower, and a second switching door configured to selectively open the second duct part. The controller is further configured to operate the first switching door and the second switching door.

In an embodiment, the refrigerant circulation passage may form a circulation passage configured to circulate along an evaporator located between the first flow path and the first duct part, a condenser located between the second flow path and the second duct part, a compressor located in a space independent of the first flow path and the second path within the housing, and an expansion valve located adjacent to the compressor.

In another embodiment, the first duct part may include a first interior duct formed to extend and protrude toward an upper end of a vehicle body and a first exterior duct disposed adjacent to the first interior duct and formed to extend and protrude toward an exterior of the vehicle. The second duct part may include a second interior duct formed to extend and protrude toward a lower end of the vehicle body and may include a second exterior duct disposed adjacent to the second interior duct and formed to extend and protrude toward the exterior of the vehicle.

In still another embodiment, the first exterior duct and the second exterior duct may be fluidly connected to a rear grille.

In yet another embodiment, the vehicular air-conditioning device may further include a positive temperature coefficient (PTC) heater located adjacent to the condenser.

In still yet another embodiment, the vehicular air-conditioning device may further include a first air volume control door located on the first flow path and a second air volume control door located on the second flow path.

In a further embodiment, the controller, in response to i) receiving the interior temperature from the interior temperature sensor, ii) comparing the interior temperature with a set value set by a user, and iii) determining that the interior temperature exceeds the set value, may be configured to control the first switching door in a direction fluidly connecting the first flow path to the first interior duct and to control the second switching door in a direction fluidly connecting the second flow path to the second exterior duct.

In another further embodiment, the controller, in response to i) receiving the interior temperature from the interior temperature sensor, ii) comparing the interior temperature with a set value set by a user, and iii) determining that the interior temperature is lower than the set value, may be configured to control the first switching door in a direction fluidly connecting the first flow path to the first exterior duct and to control the second switching door in a direction fluidly connecting the second flow path to the second interior duct.

In still another further embodiment, the controller, in response to i) receiving the interior temperature from the interior temperature sensor, ii) comparing the interior temperature with a set value set by a user, and iii) determining that the interior temperature is equal to the set value, may be configured to control the first switching door in a direction fluidly connecting the first flow path to the first interior duct and the first exterior duct and to control the second switching door in a direction fluidly connecting the second flow path to the second interior duct and the second exterior duct.

In another aspect, the present disclosure provides a vehicular air-conditioning device for cooling and heating. The vehicular air-conditioning device includes: a housing located adjacent to a rear seat area of a vehicle; a blower located inside the housing; a main flow path configured to surround the blower; a first flow path fluidly connected to one end of the main flow path; a second flow path fluidly connected to the other end of the main flow path; heat exchange units respectively located on the first flow path and the second flow path; a compressor located between the heat exchange units and disposed adjacent to an outer surface of the main flow path; a first duct part fluidly connected to one end of the first flow path; and a second duct part fluidly connected to one end of the second flow path. The first flow path and the first duct part are fluidly connected to each other through a first switching door and the second flow path and the second duct part are fluidly connected to each other through a second switching door.

In an embodiment, the vehicular air-conditioning device may further include a first air volume control door located at a front end of the first flow path and a second air volume control door located at a front end of the second flow path.

In another embodiment, the heat exchange units may include an evaporator located on the first flow path, and a condenser located on the second flow path.

In still another embodiment, the first duct part may include a first interior duct fluidly connected to an upper end of a vehicle body and a first exterior duct disposed adjacent to the first interior duct and formed to extend and protrude toward an exterior of the vehicle. The second duct part may include a second interior duct fluidly connected to a lower end of the vehicle body and a second exterior duct disposed adjacent to the second interior duct and formed to extend and protrude toward the exterior of the vehicle.

In yet another embodiment, the first exterior duct and the second exterior duct may be fluidly connected to a rear grille.

In still yet another embodiment, the vehicular air-conditioning device may further include a PTC heater located adjacent to the condenser.

Other aspects and embodiments of the disclosure are discussed below.

It is to be understood that the terms “vehicle”, “vehicular”, and other similar terms as used herein are inclusive of motor vehicles in general. Such motor vehicles may encompass passenger automobiles including sport utility vehicles (SUV), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, vehicles powered by both gasoline and electricity.

The above and other features of the disclosure are discussed below.

### BRIEF DESCRIPTION OF THE DRAWINGS

The above and other features of the present disclosure are now described in detail with reference to certain embodiments thereof illustrated in the accompanying drawings, which are given hereinbelow by way of illustration only, and thus are not limitative of the present disclosure, and wherein:

FIG. 1 is a perspective view of a vehicular air-conditioning device for cooling and heating according to an embodiment of the present disclosure;

FIG. 2 is a view showing a flow of air and an operation state of a switching door in a cooling mode according to an embodiment of the present disclosure;

FIG. 3 is a view showing a flow of air and an operation state of a switching door in a heating mode according to an embodiment of the present disclosure; and

FIG. 4 is view showing a flow of air and an operation state of a switching door in a mild mode according to an embodiment of the present disclosure.

It should be understood that the appended drawings are not necessarily drawn to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawings.

### DETAILED DESCRIPTION

Hereinafter, reference is made in detail to various embodiments of the present disclosure. Examples of various embodiments are illustrated in the accompanying drawings and described below. While the disclosure is described in conjunction with certain embodiments, it should be understood that the present description is not intended to limit the disclosure to the embodiments. On the contrary, the disclosure is intended to cover the disclosed embodiments, as well as various alternatives, modifications, equivalents, and other embodiments, which may be included within the spirit and scope of the disclosure as defined by the appended claims. The embodiments are provided to explain the technical concepts of the disclosure more fully to those of ordinary skill in the art.

Terms such as “part”, “unit”, and “module” described in the specification mean a unit configured to process at least one function or operation. The unit may be implemented by hardware or software or a combination of hardware and software.

The terms used in the specification are merely used to describe specific embodiments and are not intended to limit embodiments. Singular forms are intended to include plural forms as well unless the context clearly indicates otherwise. Further, when a certain component is said to be “adjacent to” another component, this may mean that the certain component is close to, near to, and/or next to the other component, and/or the certain component is disposed within a predetermined distance from the other component.

When a portion “comprises” or “includes” a certain component throughout the specification, this means that the portion may further comprise or include other components without excluding the other components unless stated otherwise. Further, terms such as “unit”, and “part” described in the specification mean a unit configured to process at least one function or operation. Furthermore, when a unit, part, module, component, controller, device, element, apparatus, or the like of the present disclosure is described as having a purpose or performing an operation, function, or the like, the unit, part, module, component, controller, device, element, apparatus, or the like should be considered herein as being “configured to” meet that purpose or to perform that operation or function.

A controller may be implemented by an algorithm configured to control the operation of various components disposed in a vehicle 10, a memory configured to store data about a program that reproduces the algorithm, and a processor configured to perform the above-described operation using data stored in the memory. In this case, the memory and the processor may be implemented as separate chips. Alternatively, the memory and the processor may be implemented as a single chip. For example, the controller may include at least one of an electronic control unit (ECU), a central processing unit (CPU), a microprocessor unit (MPU), a microcontroller unit (MCU), an application processor (AP), or any type of processor well known in the technical field of the present disclosure.

In addition, the application processor (AP) may be configured as a processor configured to perform a function of controlling a vehicular air-conditioning device for cooling and heating.

Furthermore, the controller may include at least one application configured to execute a method according to embodiments of the present disclosure, or the same may be formed of a combination of software capable of performing an arithmetic operation on a program and hardware.

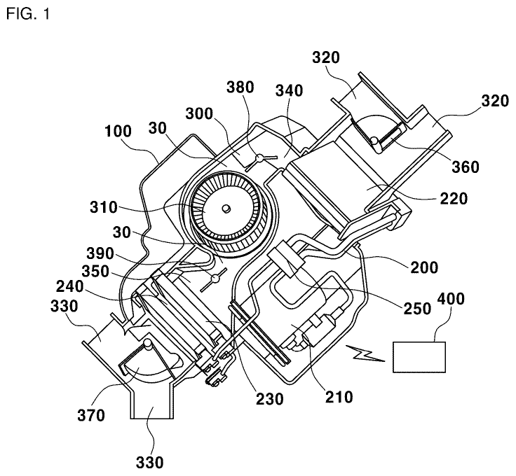

In addition, as an example, one end of a housing 100 (shown in FIG. 1) may be located in a direction facing an upper end of a vehicle body 11 in the vehicle 10 height direction, and the other end of the housing 100 may be located in a direction facing a lower end of the vehicle body 11 in the vehicle 10 height direction.

In addition, in the following specification, the upper end means a direction facing the upper end of the vehicle body 11 in the vehicle 10 height direction, and the lower end means a direction facing the lower end of the vehicle body 11.

Hereinafter, embodiments are described in detail with reference to the accompanying drawings. In describing embodiments with reference to the accompanying drawings, the same or corresponding components are denoted by the same reference numerals and redundant description thereof has been omitted.

FIG. 1 is a perspective view of a vehicular air-conditioning device for cooling and heating.

According to an embodiment of the present disclosure, the vehicular air-conditioning device for cooling and heating is configured to include all of the components of a heat pump and configured to be mounted adjacent to a rear seat 20 in a rear seat 20 area of a vehicle 10. In addition, the vehicular air-conditioning device for cooling and heating may be located on each of the left side and the right side of the rear seat 20. The vehicular air-conditioning device for cooling and heating may be located on a C-pillar of the vehicle 10 or on both C-pillars.

In addition, the vehicular air-conditioning device according to an embodiment of the present disclosure may include the housing 100 and all of the components provided in the housing 100, such as a compressor 210, an evaporator 220, a condenser 230, and an expansion valve 250. Additionally, the housing 100 may be located at the rear end of the vehicle 10. Furthermore, the housing 100 may be mounted adjacent to the rear seat 20 of the vehicle 10. The housing 100 may be located on the C-pillar of the vehicle 10 and may be located on each of the left side and the right side of the rear seat 20.

In addition, the housing 100 has a blower 310 mounted therein and configured to cause introduced external air to flow into the evaporator 220 and condenser 230. Additionally, the housing 100 is configured to include an air circulation passage 300 configured to allow the air introduced through the blower 310 to exchange heat in the evaporator 220 and condenser 230 and to flow to the interior or the exterior of the vehicle 10. Moreover, an air volume control door configured to control the air volume may be located in the air circulation passage 300. A refrigerant circulation passage 200 configured to allow refrigerant to circulate along the refrigerant circulation passage 200 may be located in the housing 100.

In addition, the air circulation passage 300 and a space independent of the air circulation passage 300 may be formed inside the housing 100.

Additionally, the blower 310 and the compressor 210 are located at the center of the housing 100. The blower 310 may be located in the air circulation passage 300. The compressor 210 may be located in the space independent of the air circulation passage 300 in the housing 100. Moreover, the expansion valve 250 may be located adjacent to the compressor 210 and may be located, similarly to the compressor 210, in the space independent of the air circulation passage 300.

Further, the evaporator 220 may be located at the upper end of the inside of the housing 100. The condenser 230 may be located at the lower end of the inside of the housing 100. The evaporator 220 and the condenser 230 may be located in the air circulation passage 300. Moreover, although the compressor 210, the expansion valve 250, the evaporator 220, and the condenser 230 are located in the separate spaces, refrigerant may circulate along the compressor 210, the expansion valve 250, the evaporator 220, and the condenser 230 through the refrigerant circulation passage 200 formed along a refrigerant pipe.

However, the positions of the blower 310, the compressor 210, the condenser 230, the evaporator 220, and the expansion valve 250 may vary depending on the type of vehicle 10, and the present disclosure is not limited to the positions thereof.

Moreover, one end of the housing 100 according to an embodiment of the present disclosure may be fluidly connected to a first duct part 320 and the other end of the housing 100 may be fluidly connected to a second duct part 330. An inlet of the first duct part 320 may be connected to the upper end of the housing 100. An inlet of the second duct part 330 may be connected to the lower end of the housing 100.

Such fluid connection may be configured through a first switching door 360 located adjacent to the first duct part 320 and a second switching door 370 located adjacent to the second duct part 330.

Further, the air circulation passage 300 may include a main flow path 30 formed apart from the blower 310 and may have a curved shape surrounding the blower 310. The air circulation passage 300 may further include a first flow path 340 through which the low-temperature air passing through the evaporator 220 flows to the interior or the exterior of the vehicle 10 and include a second flow path 350 through which the high-temperature air passing through the condenser 230 flows to the interior or the exterior of the vehicle 10.

In addition, the first flow path 340 may be formed at the upper end of the blower 310. The second flow path 350 may be formed at the lower end of the blower 310. The first flow path 340 may be formed at the upper end of the main flow path 30 and may be fluidly connected to the first duct part 320. Further, the second flow path 350 may be formed at the lower end of the main flow path 30 and may be fluidly connected to the second duct part 330.

Furthermore, the first flow path 340 is fluidly connected to the main flow path 30. Moreover, the first flow path 340 may be configured to have a larger cross-sectional area in a direction oriented from one end facing the main flow path 30 to the other end facing the first duct part 320. Further, the evaporator 220 is located on the first flow path 340. The front end of the evaporator 220 means a direction facing one end of the first flow path 340. The rear end of the evaporator 220 means a direction facing the first duct part 320.

In addition, the first duct part 320 may include a first interior duct 321 formed to extend and protrude toward the upper end of a vehicle body 11 and a first exterior duct 322 fluidly connected to a rear grille (40) of the vehicle body 11. Moreover, an inlet of the first interior duct 321 may be located to be perpendicular to an inlet of the first exterior duct 322 in the vehicle 10 length direction.

Furthermore, the second flow path 350 is fluidly connected to the main flow path 30. The second flow path 350 may be configured to gradually increase a cross-sectional area thereof in a direction oriented from one end facing the main flow path 30 to the other end facing the second duct part 330. In other words, the second flow path 350 may be formed in a trumpet shape. In addition, the condenser 230 is located on the second flow path 350. The front end of the condenser 230 means a direction facing one end of the second flow path 350. The rear end of the condenser 230 means a direction facing the second duct part 330.

In addition, in order to increase the amount of air flowing into the condenser 230 compared to the amount of air flowing into the evaporator 220, a cross-sectional area of one end of the first flow path 340 may be smaller than a cross-sectional area of one end of the second flow path 350.

Further, the condenser 230 may be located on the second flow path 350, and a positive temperature coefficient (PTC) heater 240 may be located adjacent to the condenser 230. Two condensers 230 may be disposed on the second flow path 350 for two-stage condensation, and the PTC heater 240 may be located between the two condensers 230.

In addition, two air volume control doors may be located in the air circulation passage 300. A first air volume control door 380 may be located on the first flow path 340. A second air volume control door 390 may be located on the second flow path 350.

The first air volume control door 380 may be located at the front end of the evaporator 220 so as to control the amount of air flowing from the blower 310 to the evaporator 220. The second air volume control door 390 may be located at the front end of the condenser 230 so as to control the amount of air flowing from the blower 310 to the condenser 230.

In addition, the amount of air required to cool the condenser 230 is larger than the amount of air used for heat exchange in the evaporator 220. Therefore, when the same output is generated from the blower 310, the first air volume control door 380 and the second air volume control door 390 may be adjusted such that the amount of air flowing into the condenser 230 is larger than the amount of air flowing into the evaporator 220.

For example, when a certain output is generated from the blower 310, a controller 400 may control the first air volume control door 380 in a direction reducing the amount of air flowing through the first flow path 340 such that the amount of air flowing into the condenser 230 is larger than the amount of air flowing into the evaporator 220. Moreover, the controller 400 may control the second air volume control door 390 such that the amount of air flowing through the second flow path 350 increases.

In this example, the first air volume control door 380 may be controlled in a direction in which the first flow path 340 is closed, whereas the second air volume control door 390 may be controlled in a direction in which the second flow path 350 is opened. Accordingly, even when the output of the blower 310 is constantly generated, heat exchange may be efficiently performed by controlling the amount of air flowing into the condenser 230 and the evaporator 220.

Furthermore, the first duct part 320 is opened or closed through the first switching door 360 located at the upper end of the housing 100. The second duct part 330 is opened or closed through the second switching door 370 located at the lower end of the housing 100.

Moreover, the first switching door 360 and the second switching door 370 may be manufactured in a fan shape. The first switching door 360 and the second switching door 370 may be rotated in the left and right directions relative to an axis penetrating the upper and lower surfaces of the housing 100. Through the fan shape, the two switching doors may be controlled to completely open or close any one of the interior duct or the exterior duct, or to open only a part of the ducts. In other words, the switching door may be configured to adjust the opening amount of the duct.

In addition, the first switching door 360 may be located adjacent to the first interior duct 321 through which air is discharged to the upper end of the vehicle body 11 and the first exterior duct 322 fluidly connected to the rear grille 40

Additionally, the second switching door 370 may be located between a second interior duct 331 through which air is discharged to the lower end of the vehicle body 11 and the front end of a second exterior duct 332 fluidly connected to the rear grille 40 (not shown). An inlet of the second interior duct 331 may be located to have a predetermined angle relative to an inlet of the second exterior duct 332 in the vehicle 10 height direction.

Furthermore, the first exterior duct 322 and the second exterior duct 332 may be configured to extend in one longitudinal direction in which the rear portion of the vehicle 10 is formed. The first exterior duct 322 and the second exterior duct 332 may be located adjacent to each other in a direction in which the first exterior duct 322 and the second exterior duct 332 approach the rear grille 40.

Additionally, air cooled through the evaporator 220 may be discharged to the upper end of the vehicle body 11 through the first switching door 360. Air heated through the condenser 230 may be discharged to the lower end of the vehicle body 11 through the second switching door 370.

When cooling is required, the air heated through the condenser 230 may flow into the second exterior duct 332 through the second switching door 370. In addition, when heating is required, the air cooled through the evaporator 220 may flow into the first exterior duct 322 through the first switching door 360.

The first exterior duct 322 and the second exterior duct 332 are fluidly connected to the rear grille 40 so that air flowing through the first exterior duct 322 and the second exterior duct 332 may be discharged to the outside.

In addition, the housing 100 has the compressor 210 located therein and configured to independently compress refrigerant into a high-temperature and high-pressure gas. The compressor 210 may be located adjacent to one side surface of the main flow path 30 located inside the housing 100.

In addition, the housing 100 according to an embodiment of the present disclosure may include the refrigerant circulation passage 200 along which the refrigerant circulates through the compressor 210, the evaporator 220, the condenser 230, and the expansion valve 250. Moreover, the refrigerant circulation passage 200 is formed of a refrigerant circulation pipe. The refrigerant circulation pipe may be made of copper having durability and thermal conductivity.

The low-temperature and low-pressure liquid refrigerant that has passed through the expansion valve 250 flows into the evaporator 220. Then, in the evaporator 220, the low-temperature and low-pressure liquid refrigerant absorbs heat from air introduced through the first flow path 340 and undergoes a phase change into the low-temperature and low-pressure gaseous refrigerant. In this process, the air introduced into the evaporator 220 is cooled.

Furthermore, the vehicle 10 evaporator 220 may be formed as a fin and tube type. In addition, the low-temperature and low-pressure liquid refrigerant flows into a tube inside the evaporator 220, and a plurality of fins may be provided in the evaporator 220 so as to increase a surface area and perform efficient heat exchange with the air introduced from the first flow path 340. In addition, the low-temperature and low-pressure gaseous refrigerant that has undergone heat exchange through the plurality of fins in the evaporator 220 flows into the compressor 210 through the refrigerant circulation passage 200.

The compressor 210 is configured to compress the low-temperature and low-pressure gaseous refrigerant introduced from the evaporator 220 into the high-temperature and high-pressure gaseous refrigerant. The compressor 210 is configured to compress the refrigerant through reciprocating action of a piston. Moreover, the swash plate type compressor 210 is mainly used as the vehicle 10 compressor 210. In the swash plate compressor 210, a swash plate is installed on a shaft, and the shaft is rotated to change rotational motion of the swash plate into reciprocating motion of the piston, thereby performing suction and compression of the refrigerant gas. Accordingly, the low-temperature and low-pressure gaseous refrigerant introduced from the evaporator 220 is pressurized by the high-temperature and high-pressure gaseous refrigerant.

In addition, the gaseous refrigerant compressed at high-temperature and high-pressure in the compressor 210 flows into the condenser 230. In the condenser 230, heat exchange is performed with the air introduced through the second flow path 350. Through such heat exchange, the high-temperature and high-pressure gaseous refrigerant undergoes phase change into the high-temperature and high-pressure liquid refrigerant.

Furthermore, as in the evaporator 220, a fin and tube type may be used for the condenser 230. Thin metal fins are arranged around a tube inside the condenser 230 to expand a heat exchange area and maximize contact with air, thereby discharging, to the outside, heat from the high-temperature and high-pressure gaseous refrigerant circulating through the tube. Accordingly, the high-temperature and high-pressure gaseous refrigerant may undergo phase change into the high-temperature and high-pressure liquid refrigerant.

Moreover, the high-temperature and high-pressure liquid refrigerant undergoes a throttling action through the expansion valve 250, and the high-temperature and high-pressure liquid refrigerant is decompressed into the low-temperature and low-pressure liquid refrigerant. In addition, the refrigerant that has passed through the expansion valve 250 flows into the evaporator 220 to exchange heat with the air introduced through the first flow path 340 from the evaporator 220.

In this manner, the refrigerant circulation passage 200 may be formed as a closed circulation circuit configured to allow the refrigerant to circulate through the compressor 210, the condenser 230, the expansion valve 250, and the evaporator 220 so as to cause heat exchange and phase change.

In addition, the refrigerant pipe may be manufactured to have different durability and diameter depending on a flow path through which the refrigerant circulates. A pipe through which the refrigerant passing through the compressor 210 flows may be formed of a material having durability higher than durability of a pipe disposed at the rear end of the evaporator 220 through which the low-pressure refrigerant flows so as to withstand high pressure.

Moreover, in order to achieve effective throttling in the expansion valve 250, a diameter of the refrigerant circulation pipe disposed at the front end of the inlet of the expansion valve 250 is designed to be smaller than a diameter of the refrigerant circulation pipe disposed at the rear end of the outlet of the expansion valve 250. Further, a flexible hose may be used as a refrigerant circulation pipe in a narrow space.

In addition, the controller 400 receives information on a current interior temperature from a vehicle interior temperature sensor 50 and compares the current interior temperature with a temperature value set by a user, thereby setting a control mode. The control mode is divided into a cooling mode in which the temperature of the vehicle 10 interior is lowered, a heating mode in which the temperature of the vehicle 10 interior is raised, and a mild mode in which the temperature of the vehicle 10 interior is maintained. The controller 400 determines a control mode as the cooling mode when the current interior temperature exceeds (i.e., is greater than) the temperature set by a user, as the heating mode when the current interior temperature is lower than the set temperature, and as the mild mode when the current interior temperature and the set temperature are the same.

Furthermore, after determining the control mode, the controller 400 controls the air volume control door and the switching door depending on the corresponding control mode.

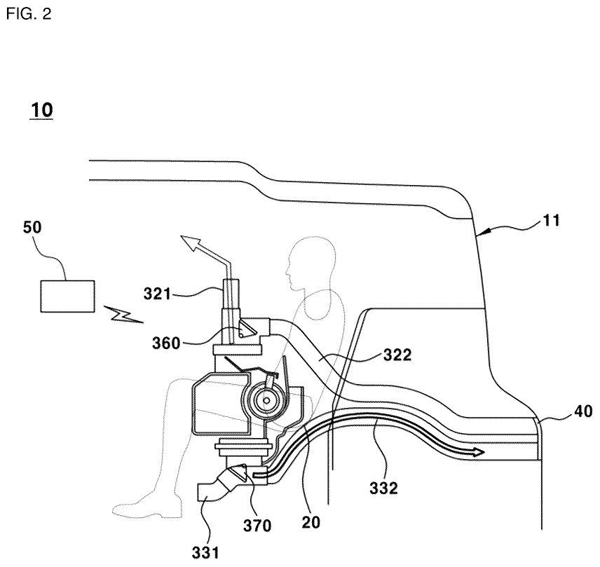

FIG. 2 is a view showing a flow of air and an operation state of the switching door in the cooling mode according to an embodiment of the present disclosure.

In an embodiment of the present disclosure, upon determining that the control mode is the cooling mode, the controller 400 controls the first switching door 360 and the second switching door 370 to lower the vehicle 10 interior temperature according to the cooling mode.

Furthermore, the controller 400 controls the first switching door 360 so as to discharge, to the upper end of the vehicle body 11, the air introduced through the first flow path 340 and cooled through the evaporator 220. The first switching door 360 is controlled in a direction in which the first interior duct 321 is opened and the first exterior duct 322 is closed. In other words, the first flow path 340 may be fluidly connected to the first interior duct 321, and the air cooled through the evaporator 220 may flow through the first interior duct 321 to be discharged to the upper end of the vehicle body 11.

At the same time, the controller 400 controls the second switching door 370 so as to discharge, to the outside of the vehicle 10, the air introduced through the second flow path 350 and heated through the condenser 230. The second switching door 370 may be controlled to close the second interior duct 331 disposed at the lower end of the vehicle body 11 and to open the second exterior duct 332. In other words, the second switching door 370 is rotated in a direction in which the outer circumferential surface of the curved shape of the second switching door 370 faces the inlet of the second interior duct 331. Through operation of the second switching door 370, the air that has exchanged heat with the condenser 230 flows to the lower end of the vehicle body 11, flows to the rear side of the vehicle 10 along the second exterior duct 332, and is discharged to the outside.

Through the above-described operating mechanism of the first switching door 360 and the second switching door 370, the air cooled through the evaporator 220 may be discharged to the vehicle 10 interior and the air heated through the condenser 230 may be discharged to the outside.

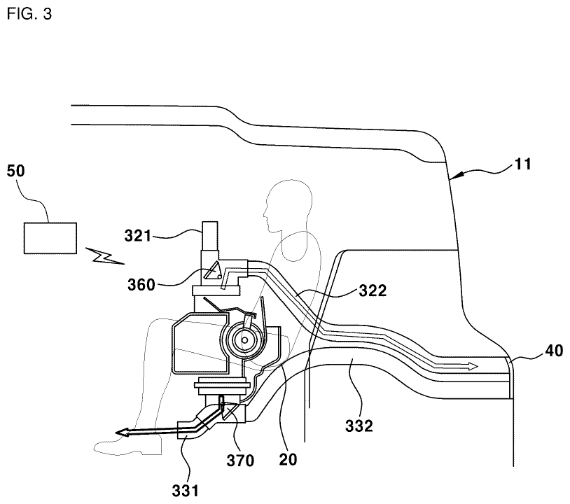

FIG. 3 is a view showing a flow of air and an operation state of the switching door in the heating mode according to an embodiment of the present disclosure.

According to an embodiment of the present disclosure, the controller 400 may control the first switching door 360, the second switching door 370, and the PTC heater 240 in a direction in which the interior temperature is raised according to the heating mode.

In the heating mode, the controller 400 controls the second switching door 370 so as to allow the air heated through the condenser 230 to flow to the lower end of the vehicle body 11. The second switching door 370 is controlled to open the second interior duct 331 fluidly connected to the lower end of the vehicle body 11 and to close the second exterior duct 332 fluidly connected to the rear grille 40 (not shown).

In addition, the inlet of the second interior duct 331 is located to have a predetermined angle relative to the inlet of the second exterior duct 332 in the vehicle 10 height direction. The second interior duct 331 is bent toward the inside of the vehicle 10. Due to the above-mentioned shape, a direction in which the heated air that has passed through the second flow path 350 flows may be configured to be bent toward the inside of the vehicle 10. Furthermore, the heated air that has passed through the condenser 230 may flow to the lower portion of the vehicle body 11 along the second interior duct 331.

Simultaneously, the first switching door 360 is rotated in a direction in which the first exterior duct 322 is opened such that the air cooled through the evaporator 220 is discharged to the outside. In this example, the cooled air that has passed through the evaporator 220 flows from the upper end of the vehicle body 11 to the rear grille 40 (not shown) along the first exterior duct 322.

Additionally, in the heating mode, the PTC heater operates as an auxiliary heat source, further increasing the temperature of the air flowing through the condenser 230.

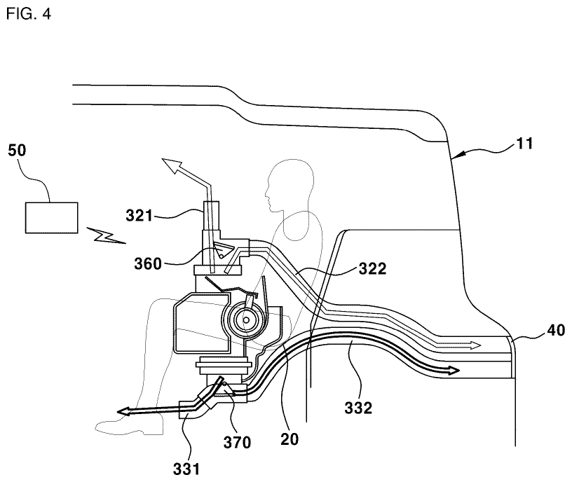

FIG. 4 is view showing a flow of air and an operation state of the switching door in the mild mode.

According to an embodiment of the present disclosure, in order to maintain the current interior temperature in response to the mild mode, the controller 400 controls the first switching door 360 and the second switching door 370 such that a part of the air cooled through the evaporator 220 and a part of the air heated through the condenser 230 are discharged to the vehicle 10 interior at the same time.

As compared with a case in which the first interior duct 321 or the first exterior duct 322 is completely opened or closed in the cooling and heating modes, in the mild mode, the controller 400 controls the first switching door 360 so as to partially open both the first interior duct 321 and the first exterior duct 322.

The first switching door 360 may be rotated in a direction in which the curved outer peripheral surface of the first switching door 360 faces the evaporator 220. Accordingly, a part of the air cooled through the evaporator 220 flows to the upper end of the housing 100 and is discharged to the upper end of the vehicle body 11 through the first interior duct 321. Moreover, a part of the cooled air flows to the upper end of the housing 100 and flows from the upper end of the vehicle body 11 to the rear grille 40 through the first exterior duct 322. In this manner, a part of the cooled air is discharged to the outside.

Moreover, the second switching door 370 may be rotated in a direction in which the curved outer peripheral surface of the second switching door 370 faces the condenser 230. In this example, the second flow path 350 may be fluidly connected to the second interior duct 331 and the second exterior duct 332, and a part of the heated air introduced through the second flow path 350 may be discharged to the lower end of the vehicle body 11 through the second interior duct 331. In addition, a part of the heated air may flow from the lower end of the vehicle body 11 to the rear grille 40 through the second exterior duct 332 and may be discharged to the outside. In other words, in the mild mode, the controller 400 controls the switching door to maintain the interior temperature by simultaneously discharging, to the vehicle 10 interior, the air that has undergone heat exchange through the evaporator 220 and condenser 230.

The present disclosure provides an independent air-conditioning device including all of the components of a heat pump independently of a main air-conditioning system, and more particularly, a vehicular air-conditioning device for cooling and heating capable of controlling air to be discharged to the interior or exterior of a vehicle 10 by utilizing one blower 310 and the switching doors respectively located at the upper portion and the lower portion of the housing 100.

As should be apparent from the above description, the present disclosure provides the following effects through the above-described configuration, combination, and usage relationship:

First, heating and cooling may be controlled through one blower, thereby making it possible to provide convenience in maintenance and repair.

Second, heating and cooling of a rear seat 20 area may be controlled independently, thereby having an effect of creating a comfortable interior environment.

Third, refrigerant may be circulated independently without being connected to a main air conditioning system through a pipe, thereby having an effect of securing stability as compared with a case in which a long pipe is used.

The technical concepts of the present disclosure have been described in detail with reference to embodiments thereof. The embodiments of the present disclosure may be used in various other combinations, modifications, and environments. In other words, it should be appreciated by those having ordinary skill in the art that changes may be made in these embodiments without departing from the principles and spirit of the disclosure, the scope of which is defined in the appended claims and equivalents thereto. The embodiments describe ways in which to implement the technical ideas of the present disclosure, and various changes required in specific application fields and uses of the present disclosure are also possible. Accordingly, the detailed description of the present disclosure is not intended to limit the present disclosure to the disclosed embodiments. Additionally, the scope of the appended claims should be construed as including other embodiments as well.

What is claimed is:

1. A vehicular air-conditioning device for cooling and heating, the vehicular air-conditioning device comprising:
a refrigerant circulation passage formed in a housing;
an air circulation passage located in the housing and configured to perform heat exchange with the refrigerant circulation passage; and
a controller configured to receive an interior temperature from an interior temperature sensor of a vehicle,
wherein the air circulation passage includes
a blower,
a first flow path formed between a first duct part located at one end of the housing and the blower,
a first switching door configured to selectively open the first duct part,
a second flow path formed between a second duct part located at another end of the housing and the blower, and
a second switching door configured to selectively open the second duct part, and
wherein the controller is further configured to operate the first switching door and the second switching door.

2. The vehicular air-conditioning device of claim 1, wherein the refrigerant circulation passage forms a circulation passage configured to circulate along:
an evaporator located between the first flow path and the first duct part;
a condenser located between the second flow path and the second duct part;
a compressor located in a space independent of the first flow path and the second flow path within the housing; and
an expansion valve located adjacent to the compressor.

3. The vehicular air-conditioning device of claim 2, further comprising a positive temperature coefficient (PTC) heater located adjacent to the condenser.

4. The vehicular air-conditioning device of claim 1, wherein:
the first duct part comprises
a first interior duct formed to extend toward an upper end of a vehicle body, and
a first exterior duct disposed adjacent to the first interior duct and formed to extend and protrude toward an exterior of the vehicle; and
the second duct part comprises
a second interior duct formed to extend and protrude toward a lower end of the vehicle body, and
a second exterior duct disposed adjacent to the second interior duct and formed to extend and protrude toward the exterior of the vehicle.

5. The vehicular air-conditioning device of claim 4, wherein the first exterior duct and the second exterior duct are fluidly connected to a rear grille of a vehicle.

6. The vehicular air-conditioning device of claim 4, wherein, in response to receiving the interior temperature from the interior temperature sensor, comparing the interior temperature with a set value set by a user, and determining that the interior temperature exceeds the set value, the controller is configured to:
control the first switching door in a direction fluidly connecting the first flow path to the first interior duct; and
control the second switching door in a direction fluidly connecting the second flow path to the second exterior duct.

7. The vehicular air-conditioning device of claim 4, wherein, in response to receiving the interior temperature from the interior temperature sensor, comparing the interior temperature with a set value set by a user, and determining that the interior temperature is lower than the set value, the controller is configured to:
control the first switching door in a direction fluidly connecting the first flow path to the first exterior duct; and
control the second switching door in a direction fluidly connecting the second flow path to the second interior duct.

8. The vehicular air-conditioning device of claim 4, wherein, in response to receiving the interior temperature from the interior temperature sensor, comparing the interior temperature with a set value set by a user, and determining that the interior temperature is equal to the set value, the controller is configured to:
control the first switching door in a direction fluidly connecting the first flow path to the first interior duct and the first exterior duct; and
control the second switching door in a direction fluidly connecting the second flow path to the second interior duct and the second exterior duct.

9. The vehicular air-conditioning device of claim 1, further comprising:
a first air volume control door located on the first flow path; and
a second air volume control door located on the second flow path.

10. A vehicular air-conditioning device for cooling and heating, the vehicular air-conditioning device comprising:
a housing located adjacent to a rear seat area of a vehicle;
a blower located inside the housing;
a main flow path configured to surround the blower;
a first flow path fluidly connected to one end of the main flow path;
a second flow path fluidly connected to another end of the main flow path;
heat exchange units respectively located on the first flow path and the second flow path;
a compressor located between the heat exchange units and disposed adjacent to an outer surface of the main flow path;
a first duct part fluidly connected to one end of the first flow path; and
a second duct part fluidly connected to one end of the second flow path,
wherein the first flow path and the first duct part are fluidly connected to each other through a first switching door, and
wherein the second flow path and the second duct part are fluidly connected to each other through a second switching door.

11. The vehicular air-conditioning device of claim 10, further comprising:
a first air volume control door located at a front end of the first flow path; and
a second air volume control door located at a front end of the second flow path.

12. The vehicular air-conditioning device of claim 10, wherein the heat exchange units comprise:
an evaporator located on the first flow path; and
a condenser located on the second flow path.

13. The vehicular air-conditioning device of claim 12, further comprising a positive temperature coefficient (PTC) heater located adjacent to the condenser.

14. The vehicular air-conditioning device of claim 10, wherein:
the first duct part comprises
a first interior duct fluidly connected to an upper end of a vehicle body, and
a first exterior duct disposed adjacent to the first interior duct and formed to extend and protrude toward an exterior of the vehicle, and
the second duct part comprises
a second interior duct fluidly connected to a lower end of the vehicle body, and
a second exterior duct disposed adjacent to the second interior duct and formed to extend and protrude toward the exterior of the vehicle.

15. The vehicular air-conditioning device of claim 14, wherein the first exterior duct and the second exterior duct are fluidly connected to a rear grille.
